(19) United States
(12) Patent Application Publication
(10) Pub. No.: US 2009/0016795 A1
(43) Pub. Date: Jan. 15, 2009

(54) HAND-HELD THERMAL TRANSFER PRINTER FOR LABELING

(75) Inventors: Jack E. Caveney, Hinsdale, IL (US); Anthony E. Clayvon, Stone Mountain, GA (US); Marc R. Obenshain, Cumming, GA (US); Robert G. Rothfritz, Gainsville, FL (US); Richard C. McConnell, Cumming, GA (US); David S. Morrison, Cumming, GA (US); Michael S. Adams, Suwanee, GA (US)

Correspondence Address: PANDUIT CORP., LEGAL DEPARTMENT - TP12, 17301 SOUTH RIDGELAND AVENUE, TINLEY PARK, IL, 60477, US

(73) Assignee: PANDUIT CORP., Tinley Park, IL (US)

(21) Appl. No.: 11/817,897

(22) PCT Filed: Mar. 16, 2006
(86) PCT No.: PCT/US06/10056

§ 371 Date: Apr. 4, 2008

Related U.S. Application Data
(60) Provisional application No. 60/662,527, filed on Mar. 16, 2005.
(60) Provisional application No. 60/717,324, filed on Sep. 15, 2005.

(51) Int. Cl. B41J 3/36; B41J 3/39; B41J 3/54; B41J 11/20

(52) U.S. Cl. 400/88; 400/691

(57) ABSTRACT

Various embodiments of a hand-held printer that includes an area for receiving a cassette carrying label material, a drive system for positioning the label material relative to a printhead, and a processing circuit for receiving inputs, producing outputs and controlling the drive system. In addition, a cassette having an ID circuit is described. The hand-held printer obtains information from the ID circuit when the cassette is inserted into the printer. The information may include, for example, a label type, label quantity, date information or information regarding printer settings for a print job previously printed from the cassette. In other embodiments, the hand-held printer may have a modular keyboard, such as a keyboard adapted for a particular application or language. The hand-held printer may include a latching mechanism that is capable of positioning a nip roller in relation to a printhead after a cassette is inserted and/or secure the cassette.

### FIELD

The present invention relates generally to labeling and, more particularly, to thermal transfer printers for labeling.

### BACKGROUND

Printing machines, or printers, are used to produce labels bearing legends, graphics, and text, such as instructions or warnings, etc. A variety of printers may be used for this application, ranging for example from large industrial printers, to commonplace desktop printers, such as laser, thermal transfer, inkjet or dot matrix printers, to portable or hand-held printers, such as a hand-held thermal transfer label printer.

Printers may print information on a variety of media, e.g., label rolls, label sheets, photographic paper, etc. For many labeling applications, labels are printed on continuous label media or a series of individual labels carried on a continuous liner or carrier. For instance, the label media may be a roll of pressure sensitive tape that is attached to a liner by an adhesive. The printer may then print a series of legends along the tape, and the individual labels are formed by cutting through the tape and liner between each pair of legends to separate each individual label from the roll. The liner would then typically be removed so that the label can be applied to its desired location.

### SUMMARY

Disclosed in various embodiments is a hand-held thermal transfer printer that preferably presents as a small and lightweight apparatus that may be produced at a low cost. The printer is configured to receive an insertable (removable) cassette that provides both label material and thermal transfer ribbon. The label material may include, for instance, continuous heat shrink tubing, vinyl self-laminating labels, polyester self-laminating labels, vinyl and polyester continuous tapes, non-adhesive labels, vinyl cloth labels, and others.

The cassette contains both label material and thermal transfer ribbon. During printing, a thermal transfer printhead supplies heat to transfer ink from the ribbon to the label material for imprinting label legends. Printed label material is fed out of the cassette and past a cutter blade for cutoff, while used ribbon is rewound on a spool inside the cassette.

The insertable cassette may be configured as a disposable cassette containing a predetermined label type. The content of the cassette indicates the cassette type, which may be further designated as a product number. A spacer may be included in the cassette to edge justify the label material, regardless of the size of the label material. Further, the ink ribbon may be reduced in size to match the label material size. Adjustable flanges of the ribbon spools may be used to edge justify the reduced ribbon rolls. According to the embodiment, a standard cassette size is available regardless of the label material and ribbon configuration of the cassette.

According to an embodiment, the cassette includes a programmable ID circuit that is configured with a code that is indicative of the cassette type or product number. When the cassette is inserted into the printer, an electronic connector, such as an edge connector, is configured to determine the cassette type based on the data stored in the ID circuit.

Further, the ID circuit may include a switch that completes a circuit to power up the printer in order to prime the cassette drive/reverse mechanisms of the printer. Thus, according to this embodiment, when the cassette is correctly loaded into a printer bay, switch may close, and in response, the printer may prime the reversing clutch.

The printer may be configured to load the insertable cassette into a cassette bay of the printer. There are a number of configurations available for attaching or locking the cassette to the printer. According to an exemplary embodiment, for instance, the cassette is loaded by dropping it into the printer from the top. Alternative, the cassette may be loaded from a bottom or side of the printer. A cassette latch or door may be used to hold the cassette in place. The door may be useful for providing a barrier to dust and dirt, for instance.

When loading the cassette, a locking mechanism may be used to hold the cassette in place and properly align a nip roller and printerhead. According to an embodiment, the latching mechanism includes a manually actuated radius arm for moving the nip roller and locking the cassette in place. Other configurations are also available.

In a complementary embodiment, the housing of the hand-held printer is an integrated mechanism frame. Thus, in this embodiment, features of the mechanism components for controlling the cassette and printing are molded, into a bottom housing of the printer as a single piece.

### BRIEF DESCRIPTION OF THE DRAWINGS

FIG. 1 is a perspective view of a hand-held thermal transfer printer and a printer cassette.

FIG. 2 is a perspective view of a hand-held thermal transfer printer and a bottom-loading printer cassette.

FIG. 3 is an exploded view of an embodiment of an attachable printer cassette including label material and ribbon.

FIG. 4 is a perspective view of an embodiment of a thermal transfer ribbon apparatus.

FIG. 5 is a block diagram showing a cassette and an edge card connector.

FIG. 6 is a block diagram showing a single-sided ID circuit board having a two-wire memory device.

FIG. 7 is a block diagram showing a double-sided ID circuit board having a two-wire memory device.

FIG. 8 is a block diagram showing a double-sided ID circuit board having a three-wire memory device.

FIG. 9 is a block diagram showing a double-sided ID circuit board having a four-wire memory device.

FIG. 10 shows a view of a cassette locking mechanism from a first perspective.

FIG. 11 shows a view of the cassette locking mechanism from a second perspective.

FIG. 12 provides an exploded view of a modular keypad and its station on a hand-held printer.

FIG. 13 provides a block diagram showing operation of a motor control circuit.

FIG. 14 provides two views of a bottom housing of an integrated printing mechanism.

### DETAILED DESCRIPTION OF THE DRAWINGS

1. Overview:

A thermal transfer printing system is disclosed that overcomes one or more disadvantages associated with existing printing systems. Specifically, an embodiment of the printing system provides hand-held battery operation with a power adapter and rechargeable batteries available as accessories, a USB port for computer interface, a modular keypad assembly for receiving user input, a graphic LCD display for providing user output, a user upgradeable operating system, a FLASH memory device, a microcontroller, a memory backup battery, and an attachable cassette that includes both labels and thermal transfer ribbon.

The attachable cassette includes features that allow the labels and ribbon to be reverse fed over a short distance. In addition, a fuse programmable circuit scheme may be included in the cassette to assist the printer in identifying the cassette type of the attachable cassette.

The printer may further include a manual cutter with partial cut capability for cutting labels once they are printed. Label offering may include both continuous and pre-cut labels, label materials including heat shrink tubing, vinyl self laminating labels, polyester self laminating labels, vinyl and polyester continuous tapes, non-adhesive labels, vinyl cloth labels, and others. In the embodiment, a cassette drive mechanism of the printer uses a DC motor and optical encoder for feedback. A label registration sensor is used to determine the start of a pre-cut label for proper label alignment.

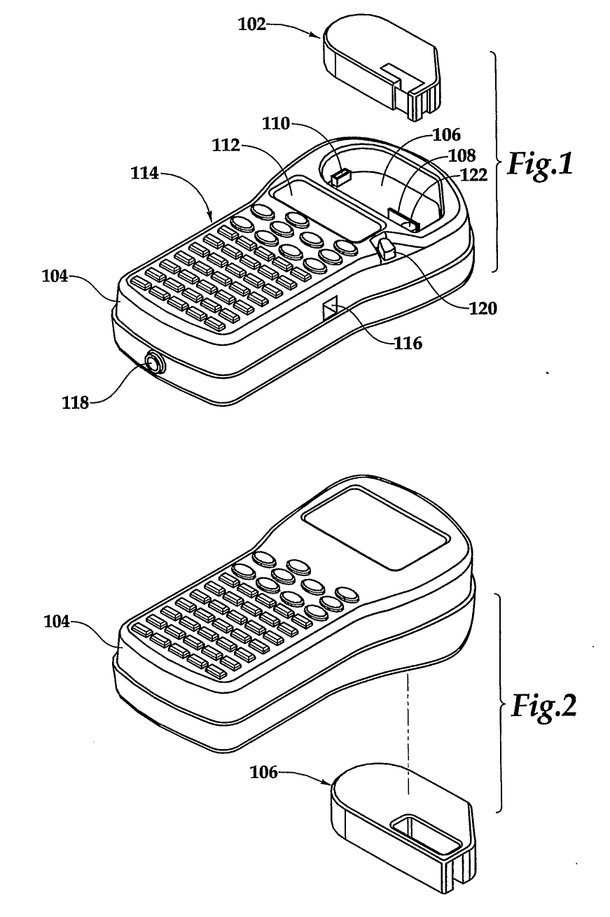

FIG. 1 provides a perspective view one embodiment of a hand-held thermal transfer printer in accordance with the invention. The figure is useful for providing an overview. A label/tape cassette 102 includes both label material and thermal transfer ribbon for printing. The cassette 102 may be loaded by placing it in the associated recess or cassette bay 106 in the printer body 104. A thermal transfer printhead 108 supplies heat to transfer ink from the ribbon to the label material for imprinting label legends. Printed label material is fed out of the cassette and past a cutter blade for cutoff, while used ribbon is rewound inside the cassette. A cutter lever 120 may be manually actuated to cut off printed labels. It is contemplated, however, that the manually actuated cutter may be replaced by an automatically or electronically actuated cutter. The printhead 108 and cutter are spaced closely together to minimize label waste.

A drive roller 122 disposed near the printhead in the cassette bay 106 provides a driving force to move printed label material out of the printer. The drive roller 122 may be made of an elastomeric material such as a silicon rubber. Alternatively, the drive roller 122 may be made of metal in order to prevent compression of the roller which could adversely affect label feed control and cut length. The drive roller may further be either textured or smooth to provide sufficient grip to drive label media from the cassette.

The printer is preferably configured to automatically recognize a cassette as it is loaded into the printer. This auto-recognition allows the printer firmware/software to automatically format print settings for that specific part number. As an example of an implementation of auto-recognition, a circuit board within each cassette may be programmed with an identifier that is unique for each cassette part number. The circuit board mates with a connector 110 in the cassette bay 106 and allows the printer firmware/software to identify the cassette type of the loaded cassette and to react accordingly. Cassette recognition using an ID circuit scheme is described in U.S. Patent Application Publication No. 20030059246. That Publication is hereby incorporated by reference into this application.

The printer body 104 includes a display 112, such as an LCD, for displaying label legends, operating instructions, and the like. In an embodiment, the display is a graphic LCD to allow display of symbols and international character sets. Label legends, operating instructions, and other user presentations may be displayed on the LCD screen. It is contemplated that multi-color display may be used for printers that print in multi-colors. Further, a touch screen interface may also be employed that may replace the need for a keypad 114. The printer keypad/keyboard 114 may be used to create label legends through the hand-held printer. Alternatively, label legends may be delivered to the printer through a PC interface, such as a PC serial interface port 116. The serial interface port 116 can be used to download label files from the PC memory (or other electronic device or memory). Likewise, the interface port 116 may be used to upload and store label files from the printer to the PC memory. Further, the serial port 116 may be used as a conduit for upgrades sent to the printer. Other interfaces, such as a parallel port or wireless connection are available to those skilled in the art.

Typically, the printer may be powered by batteries 124. However, in an embodiment, the printer can be optionally powered via a power line adapter 118. The power line adapter 118 may deliver power either as AC or DC current. Further, the power line adapter 118 may be used to recharge the batteries.

In FIG. 1, the cassette is loaded into a top side of the printer. Thus, the printer configuration is described as top loading. Other printer configurations are available. For instance, FIG. 2 provides a perspective view of a bottom loading printer. As shown, the label cassette 102 is configured to attach to a bottom side of the hand-held thermal transfer printer 104.

2. Cassette:

According to an embodiment, the cassette system used in the thermal printer provides a source that may be loaded with either continuous or pre-cut labels coupled with thermal transfer ribbon. Label materials include, but are not limited to, continuous heat shrink tubing, vinyl self-laminating labels, polyester self laminating labels, vinyl and polyester continuous tapes, non-adhesive labels, vinyl cloth labels, and others.

The cassette may provide a molded pocket or holding area for reversed labels to avoid label wrinkling. The pocket allows for slack in the label material while reversing. Further, the cassette may include molded-in ribbon tension control for maintaining tension on the ribbon—and thus preventing ribbon wrinkle. To reduce part count and cost, this feature is molded-in the cassette casing. The cassette may also include an ID circuit such as that described in U.S. Patent Application Publication No. 20030059246. According to an embodiment, 256 or more cassette recognition codes may be provided for the various cassette types available.

Advantageously, a single size cassette may be generally suitable for all label supplies. (One size fits all). This single-size feature is accomplished by including a spacer whose thickness depends upon the label size. In the embodiment, labels and ribbon should be edge justified within the cassette, rather than center justified, with the spacer pressed against the opposite, unjustified edge. Ribbons may then be matched with label widths. In a further embodiment, when pre-cut labels are used, a registration slot is provided between the labels at a fixed distance from the justified edge to ensure proper alignment. Other elements may be used to ensure that the pre-cut labels are properly aligned.

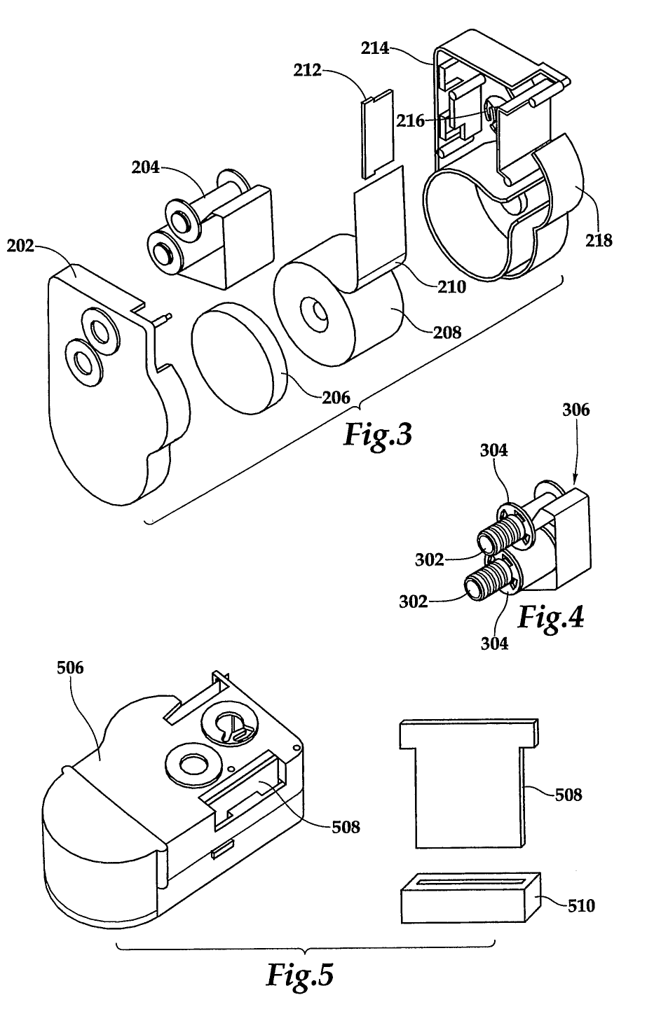

FIG. 3 provides an exploded view of an exemplary cassette. The cassette bottom 202 and top 214 provide a cassette casing that encloses the inner-workings of the cassette. These casing elements 202, 214 are made of a plastic, although other elements may be used. The cassette top 202 is configured to press fit onto the cassette bottom 214. The cassette top 202 includes two holes that correspond to the two ribbon spools shown as part of the thermal transfer ribbon apparatus 204. The two spools include a wind-out spool that holds unused ribbon and a collection spool for collecting used ribbon. In use, drive shafts controlled by the printer are inserted through the two holes in the cassette bottom 202 and control the speed and direction of the spools and thus the ribbon. The cassette bottom 214 is configured to hold all the parts that make-up the cassette. Molded springs in the cassette bottom 214 help to reduce ribbon slack while the cassette is held outside of the printer.

An ID circuit 212 contains information relating to the cassette type. This information may be encoded as a product identification code, for example. Further, the ID circuit 212 may include specification information relating to label type, label size, ribbon type and ribbon color, for instance. The ID circuit 212 is configured to link to the cassette. Further, an edge of the ID circuit 212 may be accessible to the outside of an assembled cassette. Thus, when the cassette is inserted into the printer, the printer connector can access information stored on the ID circuit 212, thus identifying the cassette type.

A circular region of the cassette top 214 having a taller wall, provides a storage area for a roll of labels 208. These labels may be pre-cut labels as shown 208, or continuous labels, or another media supply. Many types of labels may be available. In an exemplary embodiment, the labels are wound on a molded core and include a 0.625 inch inside diameter and a 1.925 inch maximum outside diameter. The molded core of the label roll is supported and centered by cassette housings. Depending upon the size of the labels 208, a spacer 206 may be useful in occupying excess space in the cassette and for preventing wrinkling and label jams. In order to align and print pre-cut labels properly, a registration slot 201 is provided. The registration slot is used to align the labels so that they are printed in the proper area rather than over the cut-lines.

The cassette top 214 may include other molded-in features that provide additional functionality to the cassette system. For instance, a molded-in tension control 216 acts like a spring operating on a drive roller of the thermal transfer ribbon. The molded-in tension control 216 ensures that tension is maintained in the ribbon and that wrinkling is eliminated or minimized.

FIG. 4 provides detail of an embodiment of the thermal transfer ribbon apparatus. Two ribbon spools 302 are shown for winding the ribbon. As the ink ribbon 304 is wound from one spool to the next, the ribbon 304 moves past a printhead of the printer, where the labels may be printed. Adjustable flanges 306 are provided for each spool. These flanges are designed to fit within and stay attached to one of the plurality of flange grooves scored in the spools 302. Thus, using the plurality flange grooves, the cassette is better able to handle ribbons of various sizes. According to an embodiment, the ribbon supply should be at least five percent more than the longest length of media. This ensures adequate ribbon supply.

3. Recognition of the Cassette:

As mentioned above, a label/tape cassette may contain any of a variety of label material. In an embodiment, the cassette casing for the various label materials may remain constant so that each cassette, containing its respective label material, will fit correctly in the space provided on the printer.

Once a cassette is inserted into the printer, the printer is configured to automatically recognize each cassette and categorize the cassette according to its cassette type. This automatic recognition operates through, for instance, firmware on the printer. Once the cassette type is known, the printer firmware may automatically format a set of optimum print settings for the specific cassette type (or cassette part number, for instance).

In an embodiment, the recognition of the cassette type is accomplished by using a small programmable board or memory device located within the cassette. The board may be programmed in the factory, for instance, with an identifier that is unique to the cassette type. When the cassette is inserted into the printer, the board mates with a connector—such as an edge connector. The connection allows an electronic data flow between the board and the printer. Through the data flow, printer firmware logic may identify the cassette type of the cassette loaded into the printer.

In an embodiment, the memory device provides a serial number for the label cassette and the label type. Further, the memory device may store label usage history such as date first used or quantity remaining. Label usage information could alternatively/additionally be stored on the printer and/or sent to a central storage area through the printer port or wireless LAN. Further, label usage information could be transferred to an enterprise resource planning (ERP) system and cause the system to update inventory information and issue purchase orders for additional cassettes, if required.

In one embodiment, the memory device in the cassette may store a label file for later retrieval by a printer when the cassette is reinserted into the same printer or is inserted in a different printer. In this embodiment, a printer memory device and a cassette memory device can both store label files. Label files comprise label legend and formatting information, including information on specific text being printed (including serialization) and formatting information such as print font and size. In this embodiment, any time the printer is in use with a cassette installed and either the printer's print button or power button is pressed, the current label file in the printer's memory will automatically be saved to the memory device in the cassette. If a file already exists in the cassette, the new file will overwrite the old file. When a label cassette is installed in a printer, the printer may first interrogate the cassette memory device to determine the type of label cassette. The printer also verifies whether the printer's current label file in its own memory is empty. There are three possible conditions that the printer will detect:
1. The cassette installed is the same type as the last cassette removed;
2. The cassette installed is a different type from the last cassette removed, and the printer's current label file is empty; or
3. The cassette installed is a different type from the last cassette removed, and the printer's current label file is not empty.

Following installation of the cassette into the printer, if the cassette is determined to be of the same type as the previous, removed cassette (e.g., the cassette has the same part number), the printer will continue to print with the label file currently stored in the printer's memory. If the cassette is determined to be of a different type from the removed cassette, the printer determines whether its own current label file is empty. If the printer's current label file is not empty, the user is prompted to save the printer's current label file if desired, and is then prompted to select between:
1. Recalling the label file from the cassette;
2. Continuing with the printer's current file; or
3. Starting with a blank file (with the cassette defaults loaded into the blank file).

If the new cassette is determined to be of a different type from the removed cassette and the printer's current label file is empty, the user may be given a choice of recalling the label file from the cassette or proceeding with a blank file into which the cassette defaults may be loaded. Saving label file information to the cassette memory and later retrieving the information eliminates the need to recreate a label file if the cassette is used in a different printer. It also eliminates the need to relocate and reload a label file stored in printer memory if it is the same file that was used the last time the cassette was inserted into the printer.

FIG. 5 provides a block diagram showing a cassette and an edge card connector. The cassette 506 includes a slot for holding an ID circuit 508, such as a flash memory card. The slot may be configured to hold the ID circuit 508 in place during use. Alternatively, the slot may be configured to allow a user to remove the ID circuit 508. A card edge connector 510 is coupled with the printer. When the cassette 506 is inserted into (or attached to) the printer, an edge of ID circuit 508 is inserted into the card edge connector 510—thus creating an electric connection between the card edge connector 510 and the ID circuit 508. Once the electric connection is created, data from the ID circuit 508 may be passed through the card edge connector 510 to the printer.

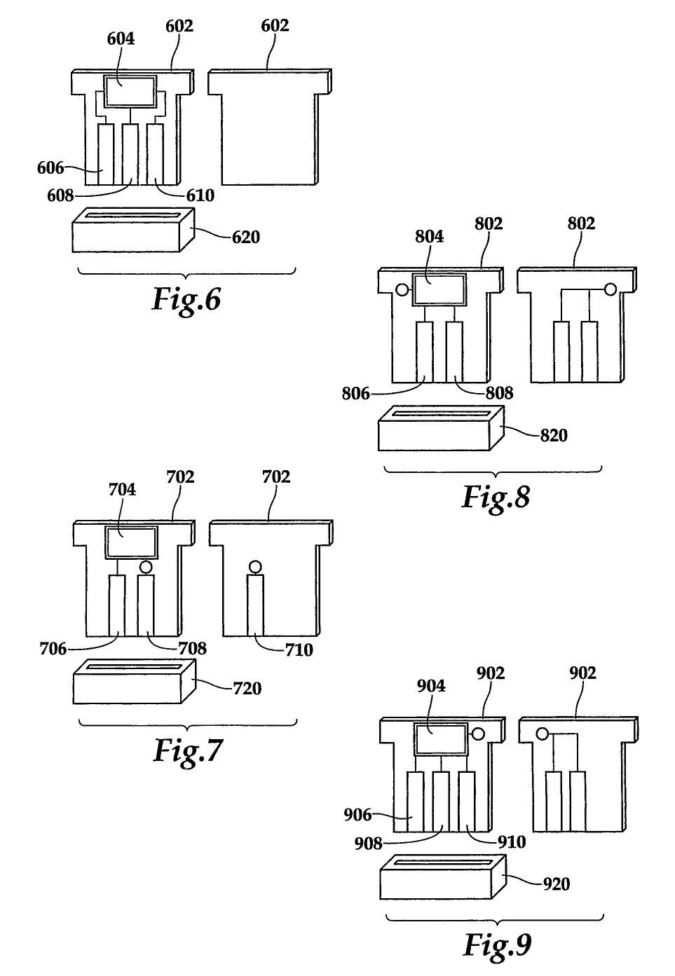

FIGS. 6-9 provide a series of embodiments of ID circuits and edge connectors. In these embodiments, the ID circuit includes both a r/w memory device and an electrical contact for completing a circuit to power-up the printer in order to prime a reversing clutch immediately after the cassette is loaded. According to the embodiments, the memory devices are configured with 2 to 4 electrical contacts each for power and data transfer. Single-sided or double sided circuit boards could be used for the ID circuit. Further, the ID circuit could plug into a common card-edge connector.

FIG. 6 shows a single-sided ID circuit board 602 having a two-wire memory device 604. Three card edge contacts are located on a single side of the ID circuit board 602 including a data/power contact 606, a common contact 608, and a switch contact 610. Conductive traces connect the edge contacts with the memory device. Further, the conductive traces connect the common contact 608 with the switch contact 610 to provide for the power-up circuit connection. This single sided connector could also be implemented with a three-wire or 4-wire memory device. More wires may create a faster or more robust memory device, for instance. A three-position card-edge connector 620 is provided at the printer for electrically connecting the printer to the card 602.

FIG. 7 shows a double-sided ID circuit board 702 having a two-wire memory device 704. Conductive traces connect the data/power contact 706 and common contact 708 with the memory device 704. A thru-hole connection 712 connects the switch connector with the common connector. A two-position card-edge connector 720 is provided at the printer for electrically connecting the printer to the card 702.

FIG. 8 shows a double sided ID circuit board 802 having a three-wire memory device 804 having separate power and data contacts. Conductive traces and a thru-hole connection 816 connect the power contact 806, data contact 808, and common contact 810 to the three-wire memory device 804. The common contact 810 is further coupled with a switch contact 812 for providing a switch circuit for printer activation. A two-position card-edge connector 820 is provided at the printer for electrically connecting the printer to the card 802.

FIG. 9 shows a double sided ID circuit board 902 having a four-wire memory device 904. Conductive traces connect the power contact 906, data contact 908, clock contact 910, and common contact 912 to the four-wire memory device 904. The common contact 912 is also coupled with a switch contact 914. A three-position card-edge connector 920 is provided at the printer for electrically connecting the printer to the card 902.

4. Reversing Clutch Priming:

When the cassette is inserted into the printer, a circuit is closed, such as that traveling from the printer through a latch connector then through a common connector and back to the printer. According to a further embodiment, the printer is configured to use that circuit closing to trigger the priming of a reversing clutch of the printer. Patent Application Ser. No. 60/662,526, Docket No. LCB507, entitled “Reversible Printer Assembly” and filed on the same day as this application provides further information regarding the reversing clutch mechanism and is hereby incorporated by reference.

The cassette reversing scheme provides that the reversing clutch be pre-tensioned or primed before the reversing function may be initiated. In normal operation, a forward motion of the ribbon during a print job primes the reversing clutch. However, if the cassette is removed from the printer, the reversing clutch may lose its priming.

A solution is provided by a function of an embodiment of the present invention that automatically primes the reversing clutch based on a triggering event that occurs when the cassette is loaded into the printer. The ID circuit that is used to indicate the cassette type may also contain a conductive contact used by a motor control circuit of the printer. The motor control circuit will use the ID circuit contact to detect the insertion of the cassette and to drive the motor, which ultimately drives a bearingless directional clutch and ribbon in the forward direction to prime the reversing clutch. Thus, the ID circuit serves a dual purpose and may eliminate a need for a separate limit switch to detect insertion of the cassette.

FIG. 13 provides a block diagram showing operation of the motor control circuit. A cassette 750 is shown having an attached ID circuit 752. When the cassette 750 is inserted into a printer, the ID circuit 752 attaches to an edge connector and provides data to the printer. In addition, the attached ID circuit 752 closes a switch to a motor control circuit 754. Once the switch is closed, the motor control circuit activates a motor 756 to commence priming the reversing clutch.

5. Cassette Latch:

In an embodiment, when the cassette is loaded into the hand-held thermal transfer printer, either the printhead or nip roller should be moved in order to allow the cassette's label and ribbon to be inserted between the printhead and ribbon and the nip roller. Additionally, the printer includes an apparatus for holding the cassette in place for stability during printing, and to prevent the cassette from falling out of the printer when turned upside-down. According to the embodiment, the printer includes a cassette latch that serves a dual purpose of sliding the nip roller and locking the cassette in place.

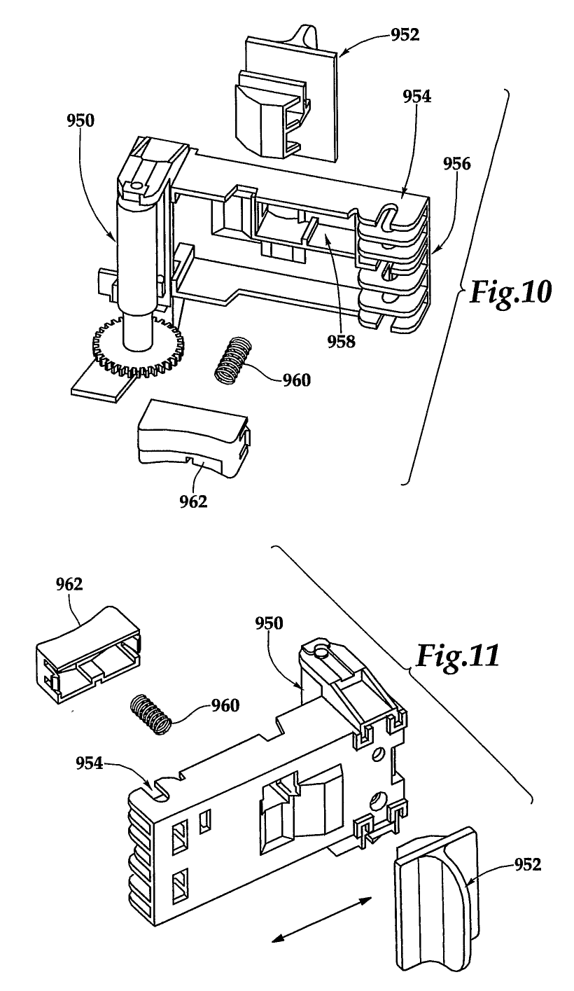

The cassette locking mechanism is shown in FIGS. 10 and 11. A radius arm 956 has a pivot point 954 at one end of the radius arm 956 and is attached to a nip roller 950 at the second end. The radius arm 956 is configured to rotate about the pivot point 954 so as to bring the nip roller 950 into proper alignment with a printhead (not shown). For instance, the radius arm 956 may rotate to push the nip roller 950 toward the cassette and the printhead. Rotation of the radius arm 956 may be encouraged by a cassette latch 952 located on a side of the printer and accessible by a user. By sliding the cassette latch 952, the user may force the radius arm 956 to rotate. Alternatively, an automatic latching mechanism may be available that uses an electric motor to rotate the radius arm 956, for instance.

A cassette lock 962 is associated with the radius arm 956, and a lock spring 960 is disposed between the radius arm 956 and cassette lock 962 to push the cassette lock 962 toward the cassette. In an embodiment, the cassette lock 962 floats freely within a lock seat 958 of the radius arm 956, and is retained by molded features. Further, the cassette may contain a mating feature that matches with the cassette lock 962 and that locks the cassette in place.

6. Modular Keypad:

Current thermal transfer printers have keypads that are integrated into and uniquely matched to the plastic or metal housing. The housing has clearance holds to accommodate each to the keys of the keypad. Additionally, a printed circuit board inside the printer housing contains key contacts—thus different housings and printed circuit boards must be used for each key layout.

Disclosed here is an embodiment of the transfer printer that includes a modular keypad where keys and key contacts are integrated into a single assembly. The modular keypad may be attached to the printer in a standardized keypad receiving area. An electrical connection to the printer for power and data flow is provided through a flexible cable. The non-unique keypad receiving area and modular keypad may be adapted to accommodate various character sets including international characters and languages. European and/or Asian languages and character sets may be accommodated, for instance. The non-unique keypad receiving area allows for unique modular keypad layouts that are particularly suited to specific vertical markets or uses. The modular keypads may also be field-interchangeable. For instance, a user might have several modular keypads that can be exchanged in the field for use in different applications.

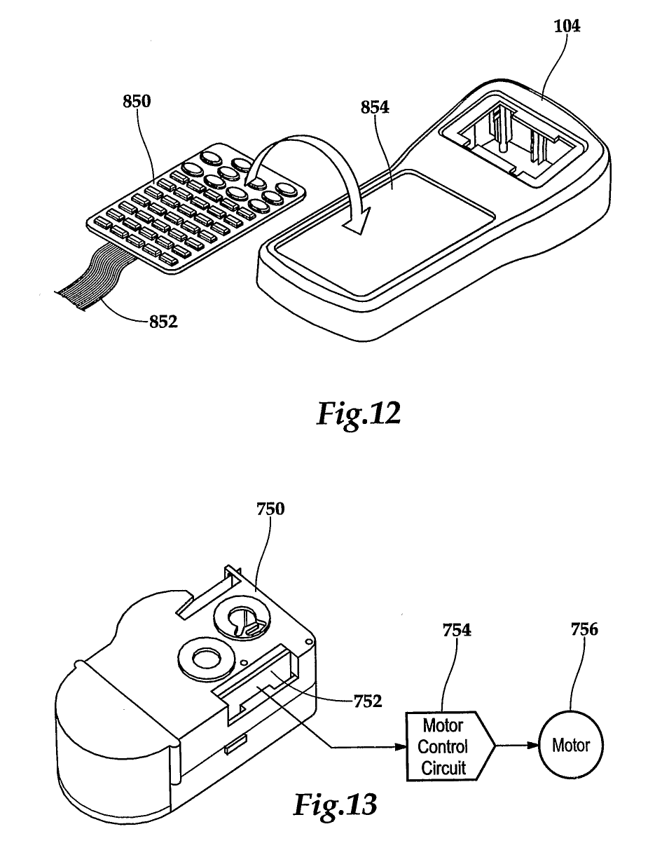

FIG. 12 provides an exploded view of a modular keypad 850 and its station on a hand-held printer 104. A flexible cable 852 provides a data connection between the modular keypad 850 and electronic components of the printer 104. The keypad 850 may be attached to the printer 104 at the keypad receiving area 854. Although the keypad receiving area 854 may take a number of forms, in an embodiment, the receiving area is substantially flat with some mechanism for latching to the modular keypad 850, such as a circumferential lip or other molded feature. A keypad release (not shown) may provide a simple apparatus for removing the keypad 850 from the printer.

In an alternative embodiment, the keyboard is bonded to the top of the housing

7. Integral Printing Mechanism:

In an embodiment, the printer may be configured by integrating the printing mechanism into the printer's plastic molded bottom housing. This configuration is accomplished by creating features in the bottom housing that capture and locate the mechanical parts. For example, gear train posts and/or alignment bosses may be molded features of the bottom housing. This direct integration results in some embodiments being produced with a cost savings achieved by eliminating the separate mechanism base (usually metal), fasteners, and other parts. Tooling costs associated with the separate parts are also eliminated.

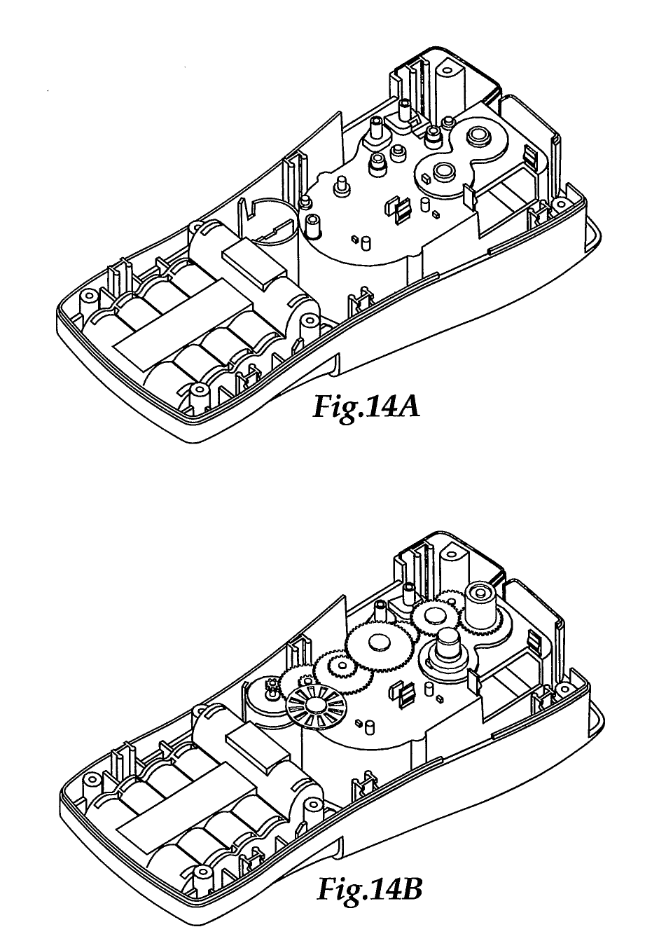

FIG. 14 provides two views of a bottom housing of an integrated printing mechanism. The upper left view shows the integrated bottom housing as a molded plastic type material. Gear train posts are molded features of the bottom housing as are alignment bosses. Other molded features may include, for instance, heat sink bracket bolt holes, bearingless directional clutch bearing surface, reversing clutch bearing surface, ID circuit hole, and a motor mount. The lower right view provides a view of the bottom housing with mechanism parts installed. These parts include, for instance gears, motors, and other elements.

1-4. (canceled)

5. In a hand-held printer that includes an area for receiving a cassette carrying label material and an ink ribbon, a drive system for positioning the label material and ink ribbon relative to a print head, and a processing circuit for receiving inputs, producing outputs and controlling the drive system, a cassette identification apparatus comprising:
a receptacle located on a surface of the hand-held printer so as to communicate with an ID circuit carried by the cassette; and
logic coupled to the receptacle, wherein the logic is adapted to read information regarding the cassette from the ID circuit.

6. The hand-held printer of claim 5, wherein the receptacle is an edge connector.

7. The hand-held printer of claim 6, wherein, when the cassette is loaded into the hand-held printer, at least a portion of the ID circuit makes physical contact with the edge connector.

8. The hand-held printer of claim 5, wherein the information comprises a label material type.

9. The hand-held printer of claim 5, wherein the information comprises a label material quantity.

10. The hand-held printer of claim 5, wherein the information comprises a date of first use of the cassette.

11. The hand-held printer of claim 5, wherein, when the cassette is loaded into the hand-held printer, the hand-held printer uses the information from the ID circuit to set print settings.

12. The hand-held printer of claim 11, wherein the ID circuit has a memory structure for storing label files and the print settings are based on the content of the label files.

13. The hand-held printer of claim 5, wherein the ID circuit comprises an electrical contact that, in communication with the receptacle, actuates the drive system to apply tension to the ink ribbon.

14. The hand-held printer of claim 13. wherein the drive system applies tension to the ink ribbon by priming a reversing clutch when the cassette is inserted into the hand-held printer.

15. A cassette for use in the hand-held printer of claim 5, the cassette including an ID circuit.

16. A cassette comprising:
a roll of label material,
an ink ribbon disposed between and supported by a pair of spools;
mechanical guide elements that position the label material and the ink ribbon in relation to a printhead when the cassette is inserted into a printer; and
an ID circuit, wherein the ID circuit stores information to identify a characteristic associated with the cassette.

17. The cassette of claim 16, wherein the ID circuit is programmable.

18. A cassette comprising:
a roll of label material,
an ink ribbon disposed between and supported by a pair of spools;
mechanical guide elements that position the label material and the ink ribbon in relation to a printhead when the cassette is inserted into a printer; and
an ID circuit, wherein the ID circuit includes a memory structure for storing a label file associated with a print job.

19-26. (canceled)
